(19) United States
(12) Patent Application Publication
(10) Pub. No.: US 2007/0004407 A1
(43) Pub. Date: Jan. 4, 2007

(54) System and method for selecting a network based on the velocity of a wireless device

(76) Inventor: Robert A. Biggs, Evanston, IL (US)

Correspondence Address: MOTOROLA, INC., 1303 EAST ALGONQUIN ROAD, IL01/3RD, SCHAUMBURG, IL, 60196, US

(21) Appl. No.: 11/171,978

(22) Filed: Jun. 30, 2005

(51) Int. Cl. H04Q 7/20

(52) U.S. Cl. 455/435.2; 455/435.1

(57) ABSTRACT

A system and method for selecting a network based upon the velocity of a wireless device is disclosed. At the wireless device wherein the wireless device has access to a velocity sensitive network, the wireless device verifies whether the velocity sensitive network is available to the wireless device. Then, the wireless device determines a velocity of the wireless device and determines that the velocity sensitive network may be appropriate for wireless communication when the velocity of the wireless device is less than a threshold for a specified duration.

### FIELD OF THE INVENTION

In general, the present invention relates to the field of communications, and more particularly, to communication networks that provide wireless communication services to wireless devices.

### BACKGROUND

Broadband wireless communication systems are increasingly being distinguished into two categories. The first category of broadband wireless communication systems is one which is suitable for wireless devices that are moving. An example of one such system is a Mesh Networks MEA system utilizing QDMA modulation (provided by Motorola, Inc.). The second category of broadband wireless communication systems is one which is suitable for wireless devices that are stationary. An example of one such system is one that adheres to IEEE 802.11a standards. The first category of broadband wireless communication systems that is suitable for wireless devices that are moving offers wireless devices wireless access. However, the wireless access that is provided to the moving wireless devices is of slower throughput than when compared to the second category of broadband wireless communication systems. Alternatively, the second category of broadband wireless communication system that is suitable for wireless devices that are stationary offers wireless devices wireless access. However, the wireless access that is provided to the stationary wireless devices does not work when the wireless devices are moving.

For a wireless device that is capable of both movement and of being stationary, being limited to either the first category or the second category limits the performance of the wireless communications. Thus, there is a need for a system and method that addresses these shortcomings.

### BRIEF DESCRIPTION OF THE FIGURES

The present invention is illustrated by way of example and not limitation in the accompanying figures, in which like references indicate similar elements, and in which:

FIG. 1 is an example of a simple block diagram illustrating a wireless communication system in accordance with some embodiments of the invention.

FIG. 2 is an example of a simple flow diagram illustrating a method in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments of the present invention, it should be observed that the present invention resides primarily in combinations of method steps and apparatus components. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

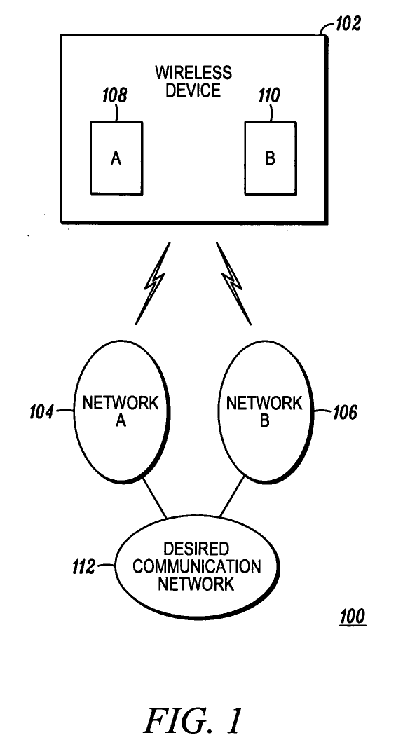

Referring to FIG. 1, shown is a wireless communication system 100 comprising a wireless device 102 with access to two networks 104, 106, namely network A 104, and network B 106. In such a wireless communication system 100, the wireless device 102 comprises two modems 108 110, namely modem A 108 and modem B 110, for access to the two networks 104, 106 where the two networks provide access to a desired communication network 112, e.g. a public switched telephone network (PSTN) or the Internet. In essence, the wireless device 102 desires efficient access to the desired communication network 112 and either network A 104 or network B 106 can provide the access for the wireless device 102. However, depending upon the velocity at which the wireless device 102 is moving, one of the networks 104, 106 may be more efficient at providing wireless access to the desired communication network 112 for the wireless device 102. As used herein, one of the networks is considered to be a “velocity sensitive” network since the network is more efficient at providing wireless access to the desired communication network 112 when the wireless device 102 is either a) stationary or b) moving at low velocities.

The wireless device 102 may include known computer devices such as mobile computers, mobile workstations, handheld devices, and other wireless computers adaptable to communicate with networks 104, 106. For example, an exemplary embodiment of wireless device 102 includes mobile computers such as a Mobile Workstation 800 (MW800) and a Mobile Laptop (ML900), both of which are available from Motorola, Inc. Further, the wireless device comprises two modems 108, 110 for interfacing with the two networks. As is known to one of ordinary skill in the art, the modems 104, 106 perform modulation and demodulation of the communications to and from the networks 104, 106. Each modem 108, 110 performs protocol specific functions that are unique to each network 104, 106 and to enable communications with each network 104, 106. Since well known, the functionality provided by each modem 108, 110 will not be further described herein. As an example, the wireless device 102 may be equipped with a CDMA modem, e.g. modem 108, and a modem adhering to an IEEE 802.16d protocol, e.g. modem 110.

Further, the wireless device 102 has intelligence to determine whether it is moving or not and to determine the velocity of the wireless device 102. In one embodiment, the wireless device 102 determines its velocity by global positioning system (GPS). As is known in the art, a typical GPS will perform a velocity determination based upon where the wireless device 102 was at a first time and where the wireless device 102 was at a second time and calculates a velocity based upon the position/time information. As is known, the Galileo navigation system can also be used to perform velocity determinations. Further, velocity can also be determined by direct coupling to vehicle sensors, e.g. tire velocity or odometer, or other known means, e.g. car on board diagnostics, and the like. Determining velocity is known and will not further be described herein.

In an alternative embodiment, the wireless device 102 supports wireless access for other wireless devices (not shown). The wireless device 102 may provide wireless access to other wireless devices (not shown) and may serve as an access point to other wireless devices for access to the desired communication network 112. In such an embodiment, the wireless device 102 may be termed a mobile router that provides routing functionality for other wireless devices (not shown) so that those other wireless devices (not shown) may have access to the desired communication network 112. In any case, the determination of which network to use is based upon the velocity at which the wireless device 102 is moving.

Even though this description is written with reference to a wireless device 102 having two modems, the mention of the two modems is not meant to be a limitation on any embodiment of the invention. Thus, as is known to one of ordinary skill in the art, the wireless device may comprise one modem that is capable of interfacing with and supporting the two networks 104, 106. For example, a single modem may be capable of supporting both IEEE 802.11b, e.g. network A 104, and IEEE 802.16e, e.g. network B 106. Thus, the mention of the number two is not meant to be a limitation and is purely an example of providing an interface to two networks.

Even though this description is written with reference to two networks, the mention of the two networks is not meant to be a limitation on any embodiment of the invention. Thus, as is known to one of ordinary skill in the art, the wireless device 102 may interface to more than two networks and may have access to more than two networks. Thus, the mention of the number two is not meant to be a limitation and is purely an example. Further, the mention of two networks is not meant to convey two separate physical networks having separate hardware. The term network is defined herein to mean a protocol. Thus, the same hardware may operate two different networks. For example, network A 104 may be an IEEE 802.16e network and network B 106 may be an IEEE 802.16d network utilizing the same hardware.

In any case, in one embodiment, network A 104 is a wireless communication network that is optimized for wireless devices that are moving and network B 106 is a wireless communication network that is optimized for wireless devices that are stationary. As an example of network A 104, a Mesh MEA network utilizing QDMA modulation (provided by Motorola, Inc.) based upon a MEA protocol is optimized for wireless devices in motion and for being able to efficiently handoff communications between wireless access points. Conversely, as an example of network B 106, an off-the shelf wireless network based on IEEE 802.11a, b, or g protocols supports high throughput for stationary wireless devices. Additional examples of network B 106 include a wireless network based upon an IEEE 802.16 protocol where the wireless network is provisioned for wireless devices that are not mobile but where the wireless network requires wide area stationary coverage.

In any case, in addition to one network being better for wireless devices that are moving and one network being better for wireless devices that are stationary, the networks 104, 106 are characterized by a modulation type. For example, network A 104 may support a first modulation type, e.g. CDMA, and network B 106 may support a second modulation type, e.g. TDMA. Further, as mentioned above, a network is characterized by protocol. For example, network A 104 may be an IEEE 802.16e network and network B 106 may be an IEEE 802.16d network.

As mentioned above, the wireless device 102 determines whether to use network A 104 or network B 106 based upon the velocity at which the wireless device is moving. In one embodiment, the decision to use one network or a second network is based purely on the velocity at which the wireless device 102 is moving. In another embodiment, the velocity at which the wireless device 102 is moving is a variable that is provided to another application that performs network selection. Thus, the variable informs the network selection application of whether to include a velocity sensitive network in the selection process.

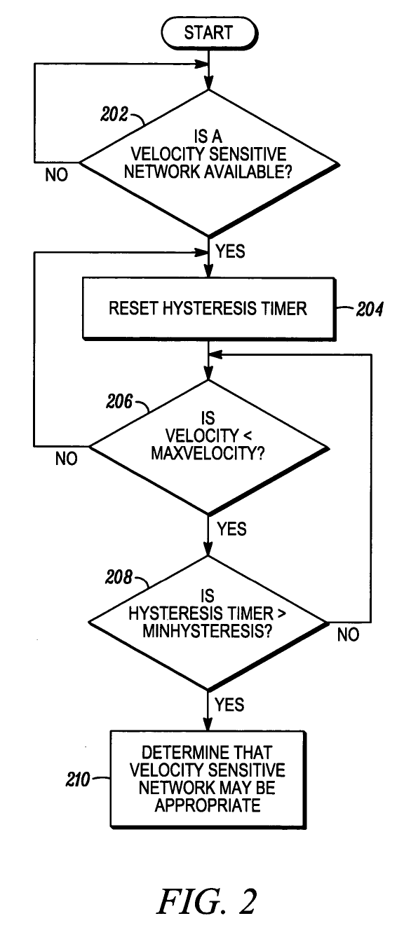

Referring to FIG. 2, shown is a method for selecting a network based upon a wireless device's velocity. In one embodiment, the method of FIG. 2 is performed by a velocity determination application performed by the wireless device 102. To begin, the wireless device 102 verifies whether a velocity sensitive network is available (Block 202). That is, does the wireless device have the option of accessing a velocity sensitive network? Is the wireless device 102 in the vicinity of a network which provides high speed wireless access to stationary devices, and if so, is such access enabled? For example, the wireless device 102 may be in the vicinity of a paid network at a coffee shop which provides such access but a user of the wireless device 102 may not have paid for such service. In such a case, the velocity sensitive network is not available. Further, the wireless device may be disabled from accessing the velocity sensitive network. In any case, the velocity sensitive network is not an option for the wireless device and the wireless device must use the network that is available regardless of whether that network is the most efficient for the wireless device to access the desired communication network 112. For example, the wireless device 102 may need to use the network that is optimized for wireless devices that are mobile even though the wireless device 102 is at present stationary.

In one embodiment, if the velocity sensitive network is available, then the wireless device 102 resets a hysteresis timer (Block 204) and determines a velocity of the wireless device. If the wireless device's velocity is less than a threshold, namely Max Velocity (Block 206), then the wireless device determines whether the velocity has been less than Max Velocity for a specified duration, namely MinHysteresis (Block 208). If the wireless device's velocity is not less than Max Velocity (Block 206), then the wireless device resets the hysteresis timer (Block 204). In such a case, even though the velocity sensitive network is available, the wireless device is moving at a velocity that is too large, e.g. the wireless device is moving too fast, for the velocity sensitive network to be used efficiently.

The value that MaxVelocity is set to depends upon the characteristics of the velocity sensitive network. For example, if Network B 106 is the velocity sensitive network and works well with wireless devices that are stationary, then Max Velocity is chosen to be a very small number. For example, a sample Max Velocity for a velocity sensitive may be approximately 1 or 2 miles an hour. In any case, characteristics that are used to determine Max Velocity include a carrier frequency of the network, the number of access points, modem receiver design, and modulation characteristics. In any case, Max Velocity may be determined by trial and error. Further, Max Velocity may be preconfigured by the wireless device 102 or may be sent in a signaling message by the network 104, 106 to the wireless device 102.

If the velocity at which the wireless device is moving at is less than Max Velocity, then the wireless device 102 determines whether the time that the velocity has been less than Max Velocity is greater than MinHysteresis (Block 208). This check ensures that the drop in velocity is not an instantaneous drop in velocity, but that the wireless device 102 has been at a velocity which is less than Max Velocity for a length of time, e.g. seconds or minutes. Thus, the wireless device 102 does not change networks based upon temporary states, e.g. if the wireless device momentarily comes to rest but then begins moving again.

In one embodiment, the value that MinHysteresis is set to may depend upon a history of the movement of the wireless device 102. For example, if the wireless device 102 stops and starts often, then MinHysteresis may be set to be larger than a duration between the frequent stops and starts. A sample MinHysteresis for a wireless device 102 may be 5 minutes. In any case, MinHysteresis may be determined by trial and error. Further, MinHysteresis may be preconfigured by the wireless device 102 or may be sent in a signaling message by the network 104, 106 to the wireless device 102.

If the wireless device has a velocity that is below Max Velocity for a length of time greater than MinHysteresis, then the wireless device 102 determines that the velocity sensitive network may be the appropriate network for wireless communications (Block 210). In one embodiment, the wireless device 102 selects the velocity sensitive network, e.g. network B 106 for wireless communications and for access to the desired communication network 112. In the absence of any network selection algorithm, the wireless device 102 performs the appropriate changes in selection of network interface and appropriate modem for communicating to the velocity sensitive network.

In a second embodiment, where the wireless device 102 has a network selection algorithm that performs determination of which network to use, the velocity determination application of the wireless device 102 indicates that the velocity sensitive network may be appropriate for wireless communication by indicating to the network selection algorithm that it has made such a determination. In this embodiment, such indication may be by passing a variable to a middleware, operating system, or other application that performs the network selection algorithm that the velocity sensitive network may be appropriate for wireless communications. By providing such an indication, the network selection algorithm may be able to choose a network that provides a higher throughput than is normally available to the wireless device 102.

It will be appreciated that embodiments of the present invention described herein may be comprised of one or more conventional processors and unique stored program instructions that control the one or more processors to implement, in conjunction with certain non-processor circuits, some, most, or all of the functions described herein. The non-processor circuits may include, but are not limited to, a radio receiver, a radio transmitter, signal drivers, clock circuits, power source circuits, and user input devices. As such, these functions may be interpreted as steps of a method. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for selecting a network based upon the velocity of a wireless device, comprising:
at the wireless device wherein the wireless device has access to a velocity sensitive network:
verifying whether the velocity sensitive network is available to the wireless device;
determining a velocity of the wireless device; and
determining that the velocity sensitive network may be appropriate for wireless communication when the velocity of the wireless device is less than a threshold for a specified duration.

2. The method of claim 1 wherein the threshold is based upon the characteristics of the velocity sensitive network.

3. The method of claim 1 wherein the specified duration is based upon a history of the movement of the wireless device.

4. The method of claim 1 further comprising selecting the velocity sensitive network for wireless access.

5. The method of claim 1 further comprising indicating that the velocity sensitive network may be appropriate for wireless communication to a network selection algorithm of the wireless device.

6. The method of claim 5 wherein the network selection algorithm is at least one of middleware, operating system, and application separate from a velocity determination application.

7. The method of claim 1 wherein the velocity sensitive network provides wireless access to the wireless device when the wireless device is at least one of a) stationary and b) moving at low velocities.

8. The method of claim 1 further comprising using a network optimized for wireless devices that are mobile.

9. The method of claim 1 wherein the wireless device comprises a first modem that provides an interface to a network that is optimized for wireless devices that are mobile and a second modem that provides an interface to the velocity sensitive network.

10. The method of claim 9 wherein the first modem and the second modem provide access to the same physical hardware for wireless access to a desired communication network.

11. The method of claim 1 wherein the step of determining the velocity is performed by at least one of Global Positioning System, Galileo, direct coupling to vehicle sensors, and on board diagnostics.

12. The method of claim 1 wherein the specified duration is determined by a timer.

13. A system for selecting a network based upon the velocity of a wireless device, comprising:
a first modem for interfacing with a first network optimized for wireless devices that are mobile;
a second modem for interfacing with a second network that is optimized for wireless devices that are stationary:
a verifier for determining that the second network is available to the system;
a velocity determiner for assessing the velocity of the system;
a processor for determining that the second network may be appropriate for wireless communication when the velocity of the system is less than a threshold for a specified duration; and
a selector that utilizes the second modem for wireless communication when the processor has determined that the second network is appropriate for wireless communication.

14. The system of claim 13 wherein the processor further comprises a hysteresis timer for determining the specified duration.

15. The system of claim 13 wherein the first network and the second network provide wired access to a desired communication network.

16. The system of claim 13 further comprising an interface to a network selection algorithm.

17. The system of claim 16 wherein the processor provides the network selection algorithm with an indication that the second network is appropriate for wireless communication.

18. The system of claim 13 wherein the velocity determiner provides a Global Positioning System interface.

19. The system of claim 13 wherein the first network and the second network differ in protocol.

20. A system for selecting a network based upon the velocity of a wireless device, comprising: in the wireless device wherein the wireless device has access to a velocity sensitive network:
means for verifying whether the velocity sensitive network is available to the wireless device;
means for determining a velocity of the wireless device; and
means for determining that the velocity sensitive network may be appropriate for wireless communication when the velocity of the wireless device is less than a threshold for a specified duration.
